(19) United States
(12) Patent Application Publication
(10) Pub. No.: US 2012/0249373 A1
(43) Pub. Date: Oct. 4, 2012

(54) Populating Non-Positional Transmitter Location Databases Using Information about Recognized Positional Transmitters

(75) Inventor: Ashok Bhatia, San Diego, CA (US)

(73) Assignee: QUALCOMM INCORPORATED, San Diego, CA (US)

(21) Appl. No.: 13/350,576

(22) Filed: Jan. 13, 2012

Related U.S. Application Data
(60) Provisional application No. 61/433,459, filed on Jan. 17, 2011.

(51) Int. Cl. G01S 5/02

(52) U.S. Cl. 342/451

(57) ABSTRACT

Methods and systems for populating and maintaining a non-positional transmitter location database are disclosed. When a mobile station detects a non-positional transmitter, the mobile station transmits information regarding the non-positional transmitter as well as information regarding recognized positional transmitters to a non-positional transmitter location (NPT_L) database server. The NPT_L database server aggregates the information received from multiple mobile stations for particular non-positional transmitter to calculate the location of the non-positional transmitter. Thus, the need to use external resources (such as drive runs) to locate non-positional transmitters is reduced.

### RELATED APPLICATIONS

The present application claims the benefit of U.S. Provisional Patent Application Ser. No.: 61/433,459, entitled “ Populating Non-Positional Transmitter Location Databases Using Information about Recognized Positional Transmitters”, by Ashok Bhatia, filed Jan. 17, 2011, and is incorporated herein in its entirety by reference.

### BACKGROUND

1. Background Field

The present invention relates to position location systems that utilize wireless signals to determine the location of an electronic device.

2. Relevant Background

Conventional positioning systems make use of a system of recognized positional transmitter to transmit distance information and identifying information to a mobile station. The mobile station processes the distance information and identifying information from the recognized positional transmitters to determine the position of the mobile station. Specifically, the distance information is measured to determine the distance between the mobile station and the recognized positional transmitters. Furthermore, recognized positional transmitters have a position that can be determined by the mobile station. For example, in satellite positioning systems (SPS) the position of the satellites can be computed by the mobile station. In other systems, the position of recognized positional transmitters is either stored in the mobile station, transmitted to the mobile station by the recognized positional transmitter, or transmitted to the mobile station from a database of recognized positional transmitters.

The position of the mobile station can be computed using the position of the recognized positional transmitters and the distance between the recognized positional transmitters and the mobile station using triangulation methods when four recognized positional transmitters are available to the mobile station.

As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

Conventional positioning systems include satellite positioning systems (SPS), such as the United States Global Positioning System (GPS), the Russian Glonass system, the European Galileo system, any system that uses satellites from a combination of satellite systems, or any satellite system developed in the future. Furthermore, many satellite positioning systems also use pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code so as to permit identification by a remote receiver. Pseudolites are useful in situations where GPS signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and others. The term “SPS signals”, as used herein, is intended to include SPS-like signals from pseudolites or equivalents of pseudolites.

Furthermore, some conventional positioning systems are created to use existing ground based transmitters such as cellular base stations as recognized positional transmitters. Thus, in some systems recognized positional transmitters encompass transceivers that can receive signals from the mobile station. Generally, the position of cellular base stations can be transmitted to the mobile station over the cellular network or stored in the mobile station.

Distance information and identifying information depends on the specific implementation of the recognized positional transmitter. For example in the United States GPS system, GPS satellites transmit satellite positioning signal, a Gold code, i.e. (a pseudo random sequence), as well as data on clock timing. For identification purposes, each GPS satellite transmits a different Gold code. The distance between the satellite and a mobile station is calculated as a pseudo range that is based on the time delay measured between the received signal from the GPS satellite and a local clock on the mobile station.

Similarly, Cellular base stations periodically transmit a pseudo-random sequence that uniquely identifies each cellular base station in the cellular network. This pseudo random sequence is often referred to as a “pilot signal If the transmit time of the pilot signal is known, a measurement of the “time of arrival” of pilot signal at the mobile station provides the distance information between the cellular base station and the mobile station.

Four recognized positional transmitters are used for triangulation. However, in many locations mobile stations are unable to receive information from four recognized positional transmitters. For example in dense urban areas, satellite signals are often blocked by tall buildings. Similarly, cellular base stations signals may suffer from various issues in urban areas, such multipath signals, reflected signals, and blocked signals. These issues may prevent a mobile stations from receiving usable signals from the cellular base stations.

To address these problems, hybrid positioning systems make use of various non-positional transmitters to augment the network or networks of recognized positional transmitters. Generally non-positional transmitters do not provide position information or distance information but can be uniquely identified by the mobile station. Examples of non-positional transmitters include wireless access points in wireless local area networks (WLAN), WiFi access points, femtocells, and Bluetooth transmitters. To make use of non-positional transmitters, a database of non-positional transmitter locations is maintained. The mobile station detects one or more non-positional transmitters and then contacts a database server that maintains the non-positional transmitter location database. Based on the set of non-positional transmitters detected by the mobile station and the positional information from the recognized positional transmitters, an approximate position for the mobile station can be determined.

However, the vast majority of non-positional transmitters are not under any control of the controllers of the hybrid positioning system. For example, many individuals will have their own wireless access points that are maintained for their private use. These wireless access points may be added, removed, or replaced at the whim of the individuals. Thus creating the non-positional transmitter location database is a very difficult task. Furthermore, even if the non-positional transmitter location data base is created, regular maintenance of the non-positional transmitter location data base must be performed to handle new, removed, replaced, or moved non-positional transmitters. As used herein, the term “populating” a non-positional transmitter location database includes both creating and maintaining the non-positional transmitter location database.

Conventionally two methods are used for populating the database of non-positional transmitter locations. For the first method, “drive runs” are used in the areas for which non-positional transmitter locations are to be collected. Specifically, a location collection station is “driven” around the area and collects information about non-positional transmitter in the area. The position of the location collection station is carefully monitored during the drive run to generate location data for the non-positional transmitters. While, the database of non-positional transmitter location would be very accurate shortly after each drive run, the database will inevitably lose accuracy over time as new non-positional transmitters are added in the area, or non-positional transmitters that are in the database are moved, removed, or replaced. Thus, periodic drive runs must be performed to maintain the accuracy of the database.

For the second method, end users of non-positional transmitters report the location of the non-positional transmitter to the database. However, in areas where conventional positioning systems are inaccurate or do not work at all (due to blocked or degraded signals from positional transmitters), the end users will have difficulty obtaining a location for the non-positional transmitter. Furthermore, not all users of non-positional transmitter will make reports to the database. In addition, some users of non-positional may report inaccurate information to the database. Thus, databases created by end user reporting of non-positional transmitters may have low accuracy and would only include a small subset of the non-positional transmitters. Specifically, the non-positional transmitters that can not be received from locations where positional transmitter signals can be received will never get into the database.

Hence there is a need for a method and system for efficiently populating a database of non-positional transmitter location for use with hybrid positioning systems that combine recognized positioning systems with non-positional transmitters.

### SUMMARY

Accordingly, the present invention provides low cost and accurate method and system for populating non-positional transmitter databases. Specifically, when a mobile station detects a non-positional transmitter, the mobile stations transmits information regarding the non-positional transmitter as well as information regarding recognized positional transmitters to a non-positional transmitter location (NPT_L) database server. The NPT_L database server aggregates the information received from multiple mobile stations for the particular non-positional transmitter to calculate the location of the non-positional transmitter. The location of the non-positional transmitter is then transmitted to the mobile station so that the mobile station can calculate a location of the mobile station. It should be noted that the mobile station does not necessarily need to acquire distance from 4 positional transmitters and come up with it's location for the present invention.

For example in a specific aspect of the invention, a database server receives position information regarding a first set of recognized positional transmitters and identification information for a non-positional transmitter from a first mobile station. Then later, the database server receives position information regarding a second set of recognized positional transmitters and identification information regarding the same non-positional transmitter from a second mobile station. The database server can combine the information from both of the mobile stations to calculate the location of the non-positional transmitter based on the position information regarding the first set of recognized positional transmitters and the position information regarding the second set of recognized positional transmitters. While in this example, only two mobile stations have been mentioned, similar concept can be extended to situations where information sent by three or more mobile stations is to be combined to calculate the location of non-positional transmitter.

The present invention will be more fully understood in view of the following description and drawings.

### BRIEF DESCRIPTION OF THE DRAWINGS

FIG. 1 is a simplified diagram of an urban setting with multiple base stations, satellites and mobile stations.

FIG. 2 is a flow diagram of a method for providing information for determining the location of a non-positional transmitter in accordance with one aspect of the present invention.

FIG. 3 is a flow diagram of a for a NPT_L database server in accordance with one aspect of the present invention.

FIG. 4 is a flow diagram of a method to calculate an approximate NPT location in accordance with one aspect of the present invention.

FIG. 5 is a block diagram of a mobile station in accordance with one aspect of the present invention.

FIG. 6 is a block diagram of a database server in accordance with one aspect of the present invention.

### DETAILED DESCRIPTION

As explained above, hybrid positioning systems make use of both recognized positioning transmitters and non-positioning transmitters to determine the position of a mobile station. However, to use non-positioning transmitters for determining the position of the mobile station, the approximate location of the non-positioning transmitter must be known to the hybrid positioning system. Thus, hybrid positioning systems maintain a non-positional transmitter location database that stores the location of non-positional transmitters that are within the areas covered by the hybrid positioning system. The present invention provides methods and systems to dynamically populate and maintain a non-positioning transmitter location database.

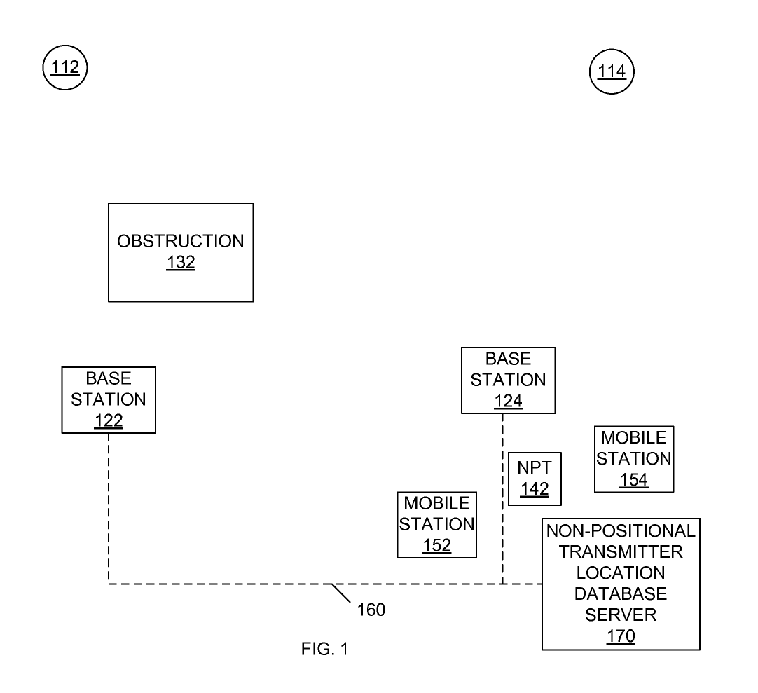

FIG. 1 illustrates a situation in which conventional hybrid positioning systems may fail to determine the position of a mobile station. FIG. 1 illustrate satellites 112 and 114, which carry recognized positional transmitters, base stations 122 and 124, which are used in a cellular phone system and also act as recognized positional transmitters, a non-positional transmitter (NPT) 142, an obstruction 132, a non-positional transmitter location database server 170 (hereinafter referred to as NPT_L database server 170), and mobile stations 152 and 154. The base stations 122 and 124 are coupled to the NPT_L database server 170 by a communications network 160. Mobile stations 152 and 154 uses hybrid positioning that combines satellite positioning, base station positioning, and positioning based on non-positional transmitters.

Obstruction 132 blocks signals from the recognized positional transmitter on satellite 112 from reaching mobile station 152. However, mobile station 152 is able to receive distance information and identifying information from base station 122, base station 124, and the recognized positioning transmitter on satellite 114. Furthermore, mobile station 152 also receives identifying information from non-positional transmitter 142. Thus, mobile station 152 receives distance information and identifying information from three recognized positional transmitter and detects a non-positional transmitter 142. As explained above, mobile station 152 would contact NPT_L database server 170 to look up the location of the non-positional transmitter 142. However, if the non-positional transmitter 142 is not in the NPT_L database maintained by the NPT_L database sever 170, mobile station 152 is not able to determine the position of mobile station 152 because four position sources are used for triangulation methods.

Mobile station 154 is able to receive distance information and identifying information from the recognized positional transmitters on satellite 112 and 114, the identifying information and distance information from mobile station 154, and identifying information from the non-positional transmitter 142. However, mobile station 154 is too far from base station 122 to receive the distance information and identifying information from the base station 122. Like mobile station 152, mobile station 154 contacts the NPT_L database server 170 to look up the location of the non-positional transmitter 142. However, if the non-positional transmitter 142 is not in the NPT_L database maintained by the NPT_L database sever 170, mobile station 154 is not able to determine the position of mobile station 154.

Similarly, other mobile stations can not use the non-positional transmitter 142 for position determination until the NPT_L database in the NPT_L database server 170 is updated with the location of the non-positional transmitter 142. As explained above conventional hybrid positioning system would not add the non-positional transmitter 142 in the NPT_L database until after a “drive run” or the owner of the non-positional transmitter 142 reports the location to NPT_L database server 170 (using some other mechanism—for example submitting its location to the database via a web interface).

However, methods and systems of the present invention can provide approximate locations for non-positional transmitter using mobile stations. In accordance with the principles of the present invention, when mobile stations detect non-positional transmitters, the mobile stations are configured to transmit distance information and identifying information from the various recognized positional transmitters and the indentifying information of the non-positional transmitter to the NPT_L database server. The NPT_L database server aggregates the information received from multiple mobile stations and calculates an approximate location for the non-positional transmitters.

Thus, for example in the scenario illustrated in FIG. 1 and described above, mobile station 152 is configured to transmit the distance and identifying information from recognized positional transmitter on satellite 114, the distance information and identifying information from base stations 122 and 124, and identifying information from the non-positional transmitter 142. RPT_L database server 170 makes the approximation that the position of the mobile station 152 is close to the location of the non-positional transmitter 152. Thus, the distance information and identifying information received by the mobile station 142 from the base stations 122 and 124 and from the recognized positional transmitter on satellite 114 is applicable for an approximate location of the non-positional transmitter 142. However, because mobile station 152 has information from only three recognized non-positional transmitters, an accurate approximate location for can not yet be calculated.

When the second mobile station 154 detects the non-positional transmitter 142, second mobile station 154 transmits the distance information and identifying information from the recognized positional transmitters on satellites 112 and 114, the distance information and identifying information for the base station 124, and identifying information for non-positional transmitter 142 to NPT_L database server 170. RPT_L database server 170 makes the approximation that the position of the mobile station 154 is close to the location of the non-positional transmitter 142. Thus, the distance information and identifying information received by the mobile station 154 from the base station 124 and from the recognized positional transmitter on satellites 112 and 114 is applicable for an approximate location of the non-positional transmitter 142. NPT_L location database server aggregates the information from mobile station 154 with the stored information previously received from mobile station 152 to calculate an approximate location for non-positional transmitter 142. The approximate location is transmitted to mobile station 154 which can now calculate a position of mobile station 154. Alternatively, NPT_L location database server 170 can calculate the position of mobile station 154 directly. Furthermore, NPT_L location database server 170 can enhance the accuracy of the approximate location of non-positional transmitter 142 by aggregating additional distance and identifying information from other mobile stations. Aggregation of distance information and identifying information from different mobile stations is described below.

For clarity, FIG. 1 includes a single non-positional transmitter (i.e. NPT 142). However, in many situations multiple non-positional transmitters would be detected by a mobile station. The same process described herein for a single non-positional transmitter can be easily applied to multiple non-positional transmitters.

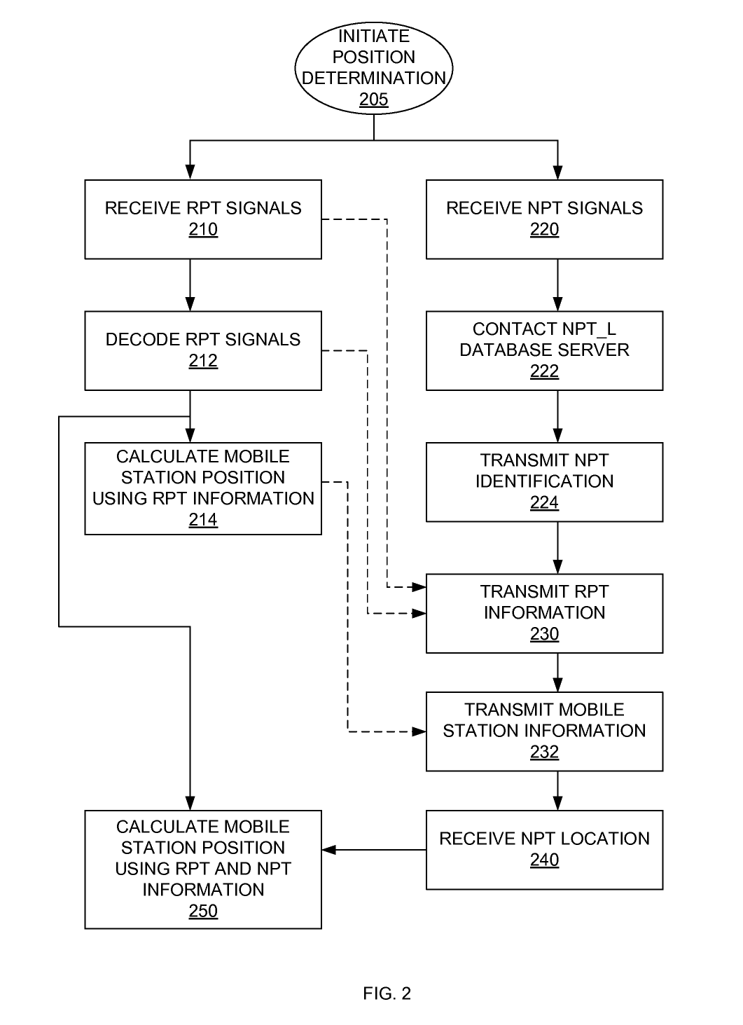

FIG. 2 is a flow diagram of a method for providing information from a mobile station for determining the location of a non-positional transmitter in accordance with one aspect of the present invention. The method of FIG. 2 begins when a mobile station attempts to determine the position of the mobile station in INITIATE POSITION DETERMINATION 205. The mobile station receives signals from recognized positioning transmitters in RECEIVE RPT SIGNALS 210. Specifically, the mobile station receives distance information and identifying information from unobstructed recognized positional transmitters within range of the mobile station. After receiving the available recognized positional transmitters signals (i.e. distance information and identifying information), the mobiles station decodes the recognized positioning transmitter signals to calculate distance measures and positions for the recognized positional transmitters in DECODE RPT SIGNALS 212. If enough (generally 4) recognized positional transmitters are available to the mobiles station, the mobile station can calculate the position of the mobile station in CALCULATE MOBILE STATION USING RPT INFORMATION 214. However, if less than enough recognized positional transmitters are available to the mobile station the mobile station attempts a hybrid position calculation using non-positional transmitters.

If unobstructed non-positional transmitters are within range of the mobile station, the mobile station receives identifying information from the unobstructed non-positional transmitters in RECEIVE NPT SIGNALS 220. For clarity, this figure only shows one mobile station, however many mobile stations may receive recognized positional transmitter signals and non-positional transmitter signals simultaneously. If any non-positional transmitters are detected, the mobile station contacts a non-positional transmitter location (NPT_L) database server in CONTACT NPT_L DATABASE SERVER 222. The mobile station then transmit identifying information about the non-positional transmitters to the NPT_L database server in TRANSMIT NPT IDENTIFICATION 224. The mobile station also transmit information about the recognized positional transmitters in TRANSMIT RPT INFORMATION 230. In accordance with one aspect of the present invention, the mobile station transmit the distance information and identifying information from each recognized positional transmitter to the NPT_L database server without decoding the information (i.e. information received in RECEIVE RPT SIGNALS 210). In accordance with another aspect of the invention, the mobile station transmit decoded information about the recognized positional transmitter such as the calculated position of the recognized positional transmitter and the distance between the recognized positional transmitter and the mobile station to the NPT_L database server (i.e. decoded information in DECODE RPT SIGNALS 212). Furthermore, the mobile station may transmit internal information about the mobile station to the NPT_L database server in TRANSMIT MOBILE STATION INFORMATION 232. For example, the mobile station might transmit internal clock data to the NPT_L data server.

In accordance with another aspect of the present invention, the mobile station may be configured to transmit the calculated position of the mobile station (i.e. the position from CALCULATE MOBILE STATION POSITION USING RPT INFORMATION 214) as part of the mobile station information to the NPT_L database server. The information transmitted to the NPT_L database server can be transmitted in any order. For example, some mobile stations in accordance with other aspects of the present invention may transmit mobile station information prior to transmitting non-positional transmitter identifying information.

The mobile station then receives a location for the non-positional transmitter from the NPT_L database server in RECEIVE NPT_LOCATION 240. However, if the NPT_L database server can not provide a location for the non-positional transmitter, the mobile station may receive a status code, error code, or message to indicate that the location of a particular non-positional transmitter is not available from the NPT_L database server. The mobile station then calculates the position of the mobile station using information about recognized positional transmitters and non-positional transmitters in CALCULATE MOBILE STATION POSITION USING RPT AND NPT INFORMATION 250. Alternatively, in accordance with some aspects of the present invention, the NPT_L database server calculates the position of the mobile station and transmits the position information to the mobile station. Thus, instead receiving the location of the non-positional transmitter, the mobile station would receive the position of the mobile station from the NPT_L database server.

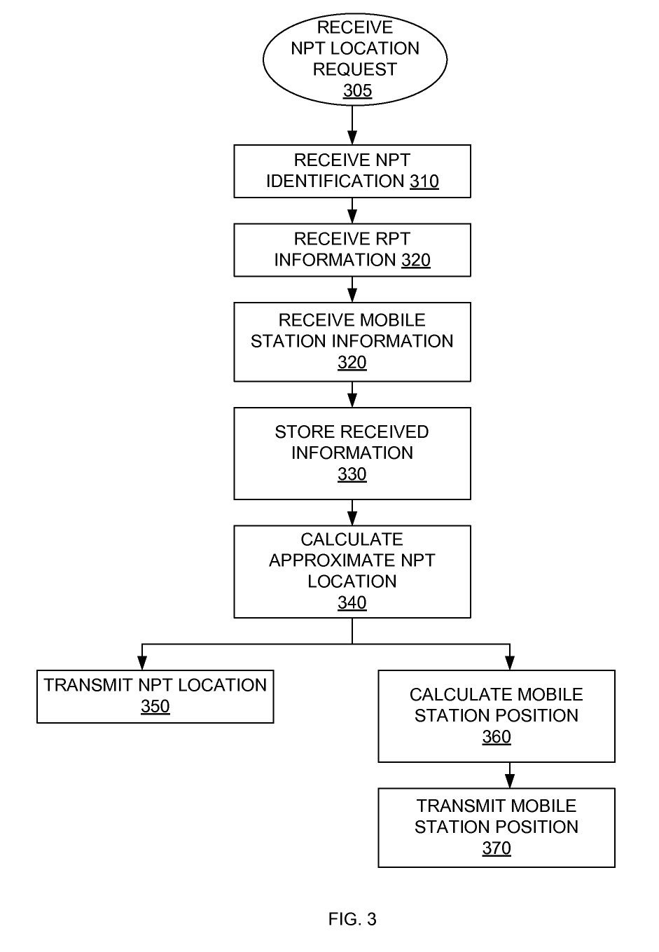

FIG. 3 is a flow diagram for a NPT_L database server in accordance with one aspect of the present invention. Specifically, the NPT_L database server begins to operate when a NPT location request is received from a mobile station in RECEIVE NPT_LOCATION REQUEST 305. The NPT_L database server then receives identifying information for the non-positional transmitter that is the subject of the location request in RECEIVE NPT IDENTIFICATION 310. The NPT_L database server also receives information regarding any recognized positional transmitters in RECEIVE RPT INFORMATION 320. As explained above, the information regarding the recognized positional transmitters can be distance information and identifying information directly as received by the mobile station from the recognized positional transmitters or could be decoded distance and position information. The NPT_L database server also receives mobile station information in RECEIVE MOBILE STATION INFORMATION 320. As explained above, the mobile station information may include internal clock data, or even the position of the mobile station as calculated by the mobile station using information from recognized positional transmitters. The NPT_L database server then stores the received information regarding the non-positional transmitter in a NPT_L database in STORE RECEIVED INFORMATION 330. The NPT_L database server calculates an approximate location for the non-positional transistor using the newly received information and previously received information regarding the non-positional transistor in CALCULATE APPROXIMATE NPT_LOCATION 340.

If the NPT_L database server is successful in calculating the approximate location of the Non-Positional transmitter by aggregating the current set of measurements with previously accumulated measurements (from other mobile stations), the NPT_L database server transmits the location to the mobile station in TRANSMIT NPT_LOCATION 350. However some versions of NPT_L database server may be configured to calculate the position of the mobile station using the information received from the mobile station and the stored information about the non-positional transmitter in CALCULATE MOBILE STATION POSITION 360. These versions of the NPT_L database server then transmits the position of the mobile station in MOBILE STATION POSITION 370.

In some aspects of the present invention the NPT_L Database Server 170, the location of a non-positional transmitter is calculated using trilateration using the information regarding the recognized positional transmitters received from the mobile station and the information received previously from other mobile stations. Furthermore, in some aspects of the present invention, some entries pertaining to a particular non-positional transmitter may be deleted as new entries are received. For example, in one aspect of the present invention, NPT_L Database Server 170 has a configurable storage threshold number of entries equal for each non-positional transmitter. If new information is received from a current mobile station regarding a specific non-positional transmitter and the storage threshold number of entries has been reached, the oldest entry pertaining to that non-positional transmitter is replaced with the information from the current mobile station. In another aspect of the present invention, rather than replacing the oldest entry, the NPT_L data base server replaces the most inaccurate entry. Accuracy in this situation is based on how closely the estimated locations based on one entry compares to the overall estimated location based on all of the entries. In another aspect of the present invention, the NPT_L database server replaces the entry that is most correlated with the other entries for the same Non-Positional transmitter.

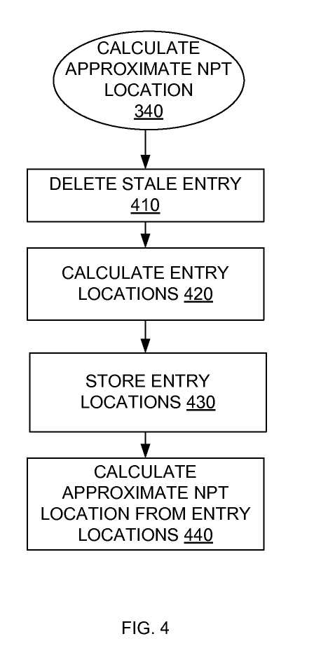

FIG. 4 is a flow diagram of a method to calculate an approximate NPT location in accordance with one aspect of the present invention. Specifically, the method illustrated in FIG. 4 performs CALCULATE APPROXIMATE NPT_LOCATION 340 in FIG. 3. First, if the number of entries already present in the NPT_L database server is already at the configured maximum number, the oldest entry is deleted in DELETE STALE ENTRY 410. Then, a set of entry locations is calculated from the information received from the mobile station (see FIG. 3). Entry locations include the possible location of the non-positional transmitter calculated from the incomplete information provided by a mobile station. The Entry locations are then stored in STORE ENTRY LOCATIONS 430. Then, an approximate location for the non-positional transmitter is calculated using all the entry locations calculated from the information from the various mobile stations that have reported sending the non-positional transmitter in CALCLUATE APPROXIMATE NPT LOCATION FROM ENTRY LOCATIONS 440. If the approximate location can be calculated successfully (using the previously stored information and combining with new information from themobile station) the approximate location is then transmitted to the mobile station (See. FIG. 3). Otherwise, the RPT information along with the identification of the non-positional transmitter is stored (until more information from other mobiles is received with the same non-positional transmitter).

Thus a hybrid positioning system using mobile stations configured to perform the method of FIG. 2 and a NPT_L database server configured to perform the method of FIG. 3 can populate and maintain a NPT_L database using information from users of the hybrid positioning system. Thus, expensive “drive runs” to locate non-positional transmitters are not required for hybrid positioning system in accordance with the present invention. Furthermore, by aggregating data from multiple mobile stations, a hybrid positioning system in accordance with the principles of the present invention can calculate locations of non-positional transistors that may not be calculated using other methods. More specifically, methods that rely on mobile stations to only send their calculated location with the identifying information of NPT transmitters may fail to calculate the position of non-positional transmitters because each individual mobile station may not get sufficient RPT measurements. However, when aggregated over multiple mobile stations, NPT_L database server can gather more RPT measurements and thus calculate the position of the non-positional transmitters.

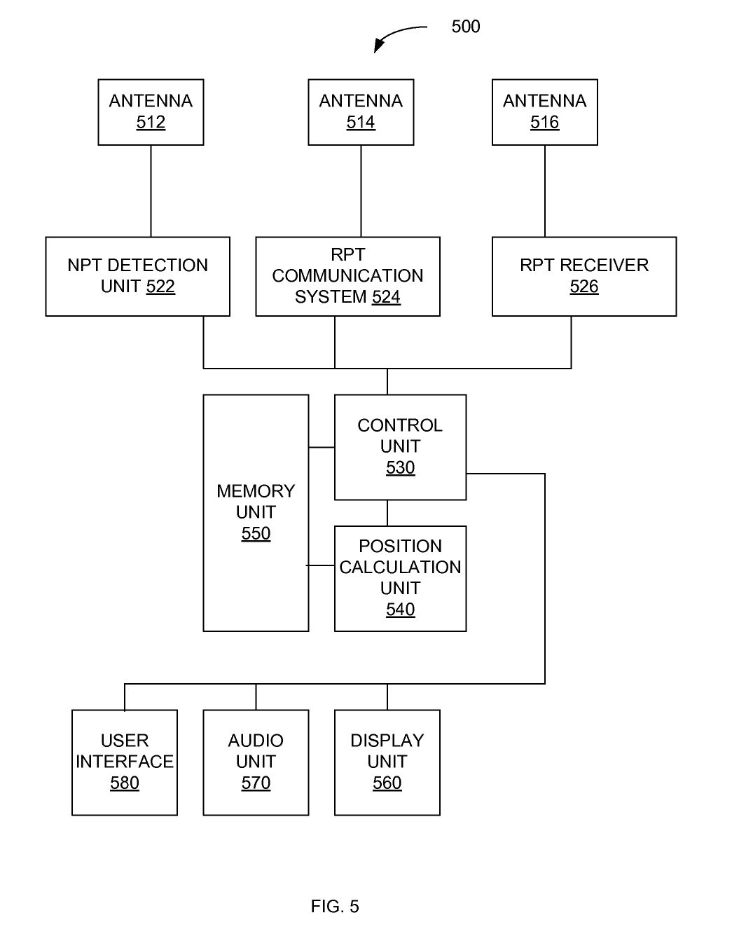

FIG. 5 is a simplified block diagram of a mobile station 500 in accordance with one aspect of the present invention. The mobile station of FIG. 5 includes antennas 512, 514, and 516, a NPT detection unit 522, an RPT communication system 524, an RPT receiver 526, a control unit 530, a memory unit 540, a position calculation unit 550, a display unit 560, an audio unit 570, and a user interface 580. NPT detection unit 522, which is coupled to antenna 512, is configured to detect non-positional transmitters in the vicinity of the mobile station and to receive identifying information from the non-positional transmitters. The indentifying information of the non-positional transmitters is provided to the control unit 530, which may store the identifying information in memory unit 540. RPT communication system 524, which is coupled to antenna 514, is configured for two-way communication with a communication network that includes recognized positional transistor and the NPT_L database server. The communication network could be for example a cellular phone network or a WiFi system connected to the internet backhaul. RPT receiver 526, which is coupled to antenna 516, is configured to receive signals from recognized positional transmitters, such as from a satellite positioning system. A control unit 530 controls NPT detection unit 522, RPT communication system 524 and RPT receiver 526. Control unit 530 generally includes a microprocessor and executes software stored in a memory unit 540. Control unit 530 is configured so that mobile station 500 can perform the method illustrated in FIG. 2 in addition to other mobile station functions. For example, in a mobile station that is also a cellular phone, control unit 530 is also configured to perform the functions necessary for a cellular phone. The mobile station 500 also includes a position calculation unit 540 which is configured to calculate the position of the mobile station 500 using the information received through NPT detection unit 522, RPT communication system 524 and RPT receiver 526. In some versions of the mobile station, position calculation unit is implemented in software executing in control unit 530. Control unit 530 also controls the display unit 560, the audio unit 570 and the user interface 580. Display unit 560, which could be for example an LCD display, is used convey information to a user. Audio unit 570 usually includes a microphone and speaker for two way voice communication. User interface 580 is used for user input into the mobile station. User interface 580 can include keypads, touch screens, voice activated systems.

In some mobile stations in accordance with other aspects of the present invention, antennas 512, 514, and 516 maybe combined into two antennas or a single antenna. Furthermore some mobile stations may omit RPT receiver 526 and antenna 516 and perform positioning using only RPT communication system 524 and NPT detection unit 522. Still other mobile stations may replace RPT communication system 524 with a communication system that is not used for position calculation.

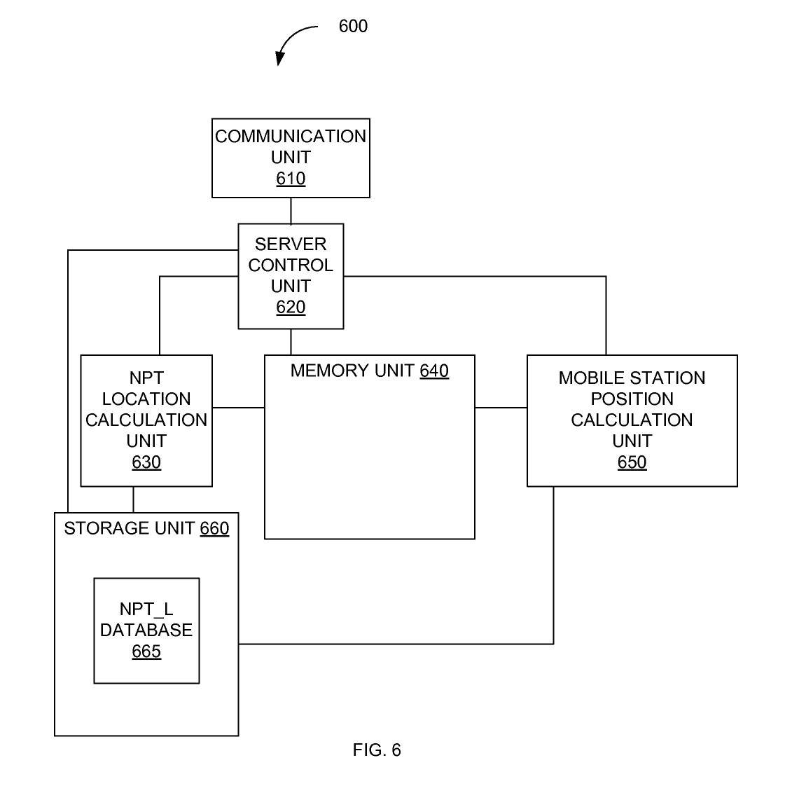

FIG. 6 is a block diagram of NPT_L database server 600, which includes a communication unit 610, a server control unit 620, a non positional transmitter (NPT) location calculation unit 630, a memory unit 640, a mobile station position calculation unit 650, a storage unit 660, and a non-positional transmitter location (NPT_L) database 665 within storage unit 660. Communication unit 610 is configured to communicate with a communication network which can also be used by mobile stations. Specifically, communication unit 610 is configured to receive information from mobile stations (as described above) and to transmit location information for non positional transmitters or position information for mobile stations. Server control unit 620, which usually includes a microprocessor to execute software stored in memory unit 640, is configured to allow NPT_L database server 600 to implement the method of FIG. 4. In addition server control unit 620 maintains the non-positional transmitter location database 665 in a storage unit 660, which can be for example a hard disk drive. NPT_L database server 600 also includes an NPT location calculation unit, which is configured to calculate the location of an non-positional transmitter based on incoming information as well as previously received information stored in the NPT_L database 665. In some versions of NPT_L database server 600, the NPT location calculation unit 630 is implemented in software that is executed by server control unit 620. Some versions of NPT_L database server 600 also include a mobile station position calculation unit 650 which is configured to calculate the position of a mobile unit based on the information received from a mobile unit and the stored information in the NPT_L database 665. Mobile station position calculation unit 650 could also be implemented in software that is executed by server control unit 620.

The methodologies described herein may be implemented by various means depending upon the application. For example, these methodologies may be implemented in hardware, firmware, software, or a combination thereof. For example, Mobile station 500 and NPT_L database server 600 are described above as using control units (including microprocessors) and memory to implement the methodologies described herein. However, in other implementation, the control units may be implemented within one or more application specific integrated circuits (ASICs), digital signal processors (DSPs), digital signal processing devices (DSPDs), programmable logic devices (PLDs), field programmable gate arrays (FPGAs), controllers, micro-controllers, electronic devices, other electronic units designed to perform the functions described herein, or a combination thereof.

Furthermore, the methodologies may be implemented with modules (e.g., procedures, functions, and so on) that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

In the various aspects of the present invention, novel methods and systems have been described for populating and maintaining a non-positional transmitter location database. The various aspects of the structures and methods of this invention that are described above are illustrative only of the principles of this invention and are not intended to limit the scope of the invention to the particular aspects described. For example, in view of this disclosure those skilled in the art can define other mobile stations, NPT detection units, RPT communication systems, RPT receivers, control units, position calculation units, NPT_L databases, NPT_L database servers, NPT location calculation units, and so forth, and use these alternative features to create a method, or system according to the principles of this invention. Thus, the invention is limited only by the following claims.

What is claimed is:

1. A method to calculate a location for a non-positional transmitter on a database server having a calculation unit and a storage unit; the method comprising:
receiving position information regarding a first set of recognized positional transmitters and identification information for a non-positional transmitter from a first mobile station;
receiving position information regarding a second set of recognized positional transmitters and identification information for the non-positional transmitter from a second mobile station; and
calculating the location of the non-positional transmitter based on the position information regarding the first set of recognized positional transmitters and the position information regarding the second set of recognized positional transmitters using the calculation unit.

2. The method of claim 1, wherein the calculating the location of the non-positional transmitter based on the position information regarding the first set of recognized positional transmitters and the position information regarding the second set of recognized positional transmitters using the calculation unit further comprises:
calculating a first set of entry locations based on the position information regarding the first set of recognized positional transmitters;
calculating a second set of entry locations based on the position information regarding the second set of recognized positional transmitters; and
calculating the location of the non-positional transmitter based on the first set of entry locations and the second set of entry locations.

3. The method of claim 2, further comprising:
storing the first set of entry locations in the storage unit; and
storing the second set of entry locations in the storage unit.

4. The method of claim 2, further comprising receiving position information regarding a third set of recognized positional transmitters and identification information for the non-positional transmitter from a third mobile station; and
calculating the location of the non-positional transmitter based on the position information regarding the first set of recognized positional transmitters, the position information regarding the second set of recognized positional transmitters and the position information regarding the third set of recognized positional transmitters.

5. The method of claim 4, wherein the calculating the location of the non-positional transmitter based on the position information regarding the first set of recognized positional transmitters, the position information regarding the second set of recognized positional transmitters and the position information regarding the third set of recognized positional transmitters further comprises:
calculating a first set of entry locations based on the position information regarding the first set of recognized positional transmitters;
calculating a second set of entry locations based on the position information regarding the second set of recognized positional transmitters;
calculating a third set of entry locations based on the position information regarding the third set of recognized positional transmitters; and
calculating the location of the non-positional transmitter based on the first set of entry locations, the second set of entry locations, and the third set of entry locations.

6. The method of claim 5, further comprising:
storing the first set of entry locations in the storage unit;
storing the second set of entry locations in the storage unit; and
storing the third set of entry locations in the storage unit.

7. The method of claim 6, further comprising deleting an oldest set of entry locations after an entry threshold number of sets of entry locations for the non-positional transmitter is calculated.

8. The method of claim 6, further comprising:
determining a most inaccurate set of entry locations for the non-positional transmitter; and
deleting the most inaccurate set of entry locations after an entry threshold number of sets of entry locations for the non-positional transmitter is calculated.

9. The method of claim 1, further comprising:
storing position information regarding the first set of recognized positional transmitters; and
storing position information regarding the second set of recognized positional transmitters.

10. The method of claim 9, further comprising deleting position information regarding an oldest set recognized positional transmitters after position information for an entry threshold number of sets of recognized positional transmitters is received.

11. The method of claim 9, further comprising:
determining a most inaccurate set of recognized positional transmitters for the non-positional transmitter; and
deleting position information regarding the most inaccurate set of recognized positional transmitters after position data regarding an entry threshold number of sets of recognized positional transmitters for the non-positional transmitter is received.

12. The method of claim 1, further comprising storing the location of the non-positional transmitter in the storage unit.

13. A system to calculate a location for a non-positional transmitter on a database server having a calculation unit and a storage unit; the system comprising:
means for receiving position information regarding a first set of recognized positional transmitters and identification information for a non-positional transmitter from a first mobile station;
means for receiving position information regarding a second set of recognized positional transmitters and identification information for the non-positional transmitter from a second mobile station; and
means for calculating the location of the non-positional transmitter based on the position information regarding the first set of recognized positional transmitters and the position information regarding the second set of recognized positional transmitters within the calculation unit.

14. The system of claim 13, wherein the means for calculating the location of the non-positional transmitter based on the position information regarding the first set of recognized positional transmitters and the position information regarding the second set of recognized positional transmitters within the calculation unit further comprises:
means for calculating a first set of entry locations based on the position information regarding the first set of recognized positional transmitters;
means for calculating a second set of entry locations based on the position information regarding the second set of recognized positional transmitters; and
means for calculating the location of the non-positional transmitter based on the first set of entry locations and the second set of entry locations.

15. The system of claim 14, further comprising:
means for storing the first set of entry locations in the storage unit; and
means for storing the second set of entry locations in the storage unit.

16. The system of claim 14, further comprising
means for receiving position information regarding a third set of recognized positional transmitters and identification information for the non-positional transmitter from a third mobile station; and
means for calculating the location of the non-positional transmitter based on the position information regarding the first set of recognized positional transmitters, the position information regarding the second set of recognized positional transmitters and the position information regarding the third set of recognized positional transmitters.

17. The system of claim 16, wherein the calculating the location of the non-positional transmitter based on the position information regarding the first set of recognized positional transmitters, the position information regarding the second set of recognized positional transmitters and the position information regarding the third set of recognized positional transmitters further comprises:
means for calculating a first set of entry locations based on the position information regarding the first set of recognized positional transmitters;
means for calculating a second set of entry locations based on the position information regarding the second set of recognized positional transmitters;
means for calculating a third set of entry locations based on the position information regarding the third set of recognized positional transmitters; and
means for calculating the location of the non-positional transmitter based on the first set of entry locations, the second set of entry locations, and the third set of entry locations.

18. The system of claim 17, further comprising:
means for storing the first set of entry locations in the storage unit;
means for storing the second set of entry locations in the storage unit; and
means for storing the third set of entry locations in the storage unit.

19. The system of claim 18, further comprising means for deleting an oldest set of entry locations after an entry threshold number of sets of entry locations for the non-positional transmitter is calculated.

20. The system of claim 18, further comprising:
means for determining a most inaccurate set of entry locations for the non-positional transmitter; and
means for deleting the most inaccurate set of entry locations after an entry threshold number of sets of entry locations for the non-positional transmitter is calculated.

21. The system of claim 13, further comprising:
means for storing position information regarding the first set of recognized positional transmitters; and
means for storing position information regarding the second set of recognized positional transmitters.

22. The system of claim 21, further comprising means for deleting position information regarding an oldest set recognized positional transmitters after position information for an entry threshold number of sets of recognized positional transmitters is received.

23. The system of claim 21, further comprising:
means for determining a most inaccurate set of recognized positional transmitters for the non-positional transmitter; and
means for deleting position information regarding the most inaccurate set of recognized positional transmitters after position data regarding an entry threshold number of sets of recognized positional transmitters for the non-positional transmitter is received.

24. The system of claim 13, further comprising means for storing the location of the non-positional transmitter in the storage unit.

25. A method of calculating a location of a first mobile station having a position calculation unit, the method comprising:
receiving position information from a first set of recognized positional transmitters;
receiving identification information from a non-positional transmitter;
transmitting the position information from the first set of recognized positional transmitters and the identification information from the non-positional transmitter to a database server;
receiving a location of the non-positional transmitter from the database server; and
calculating the location of the first mobile station based on the position information and the location of the non-positional transmitter using the calculation unit.

26. The method of claim 25, wherein the location of the non-positional transmitter was calculated using position information from a second set of recognized positional transmitters.

27. The method of claim 26, wherein the position information from the second set of recognized positional transmitters was transmitted to the database server by a second mobile station.

28. The method of claim 26, wherein the location of the non-positional transmitter was calculated using the position information from the first set of recognized positional transmitters and the position information from the second set of recognized positional transmitters.

29. A system for calculating a location of a first mobile station having a position calculation unit, the system comprising:
means for receiving position information from a first set of recognized positional transmitters;
means for receiving identification information from a non-positional transmitter;
means for transmitting the position information from the first set of recognized positional transmitters and the identification information from the non-positional transmitter to a database server;
means for receiving a location of the non-positional transmitter from the database server; and
means for calculating the location of the first mobile station based on the position information and the location of the non-positional transmitter using the calculation unit.

30. The method of claim 29, wherein the location of the non-positional transmitter was calculated using position information from a second set of recognized positional transmitters.

31. The method of claim 30, wherein the position information from the second set of recognized positional transmitters was transmitted to the database server by a second mobile station.

32. The method of claim 30, wherein the location of the non-positional transmitter was calculated using the position information from the first set of recognized positional transmitters and the position information from the second set of recognized positional transmitters.

33. A database server for storing location information regarding non-positional transmitters, the database server comprising:
a communication unit configured to receive position information regarding a first set of recognized positional transmitters and identification information for a non-positional transmitter from a first mobile station and configured to receive position information regarding a second set of recognized positional transmitters and identification information for the non-positional transmitter from a second mobile station;
a storage unit for storing the position information regarding the first set of recognized positional transmitters and the position information regarding the second set of recognized positional transmitters; and
a non-positional transmitter location calculation unit configured to calculate the location of the non-positional transmitter.

34. The database server of claim 33, wherein the non-positional transmitter location calculation unit uses the position information regarding the first set of recognized positional transmitters and the position information regarding the second set of recognized positional transmitters to calculate the location of the non-positional transmitter.

35. The database server of claim 33, further comprising a mobile station position calculation unit configured to calculate the position of the second mobile station.

36. The database server of claim 35, wherein the mobile station position calculation unit uses the location of the non-positional transmitter calculated by the non-positional transmitter location calculation unit to calculate the position of the second mobile station.

37. The database server of claim 35, wherein the communication unit is configured to transmit the location of the second mobile station.

38. The database server of claim 34, wherein the communication unit is configured to transmit the location of the non-positional transmitter.

39. A tangible machine readable medium including program code stored thereon, comprising:
program code to receive position information regarding a first set of recognized positional transmitters and identification information for a non-positional transmitter from a first mobile station;
program code to receive position information regarding a second set of recognized positional transmitters and identification information for the non-positional transmitter from a second mobile station; and
program code to calculate the location of the non-positional transmitter based on the position information regarding the first set of recognized positional transmitters and the position information regarding the second set of recognized positional transmitters using the calculation unit.

40. The tangible machine readable medium of claim 39, further comprising:
program code to calculate a first set of entry locations based on the position information regarding the first set of recognized positional transmitters;
program code to calculate a second set of entry locations based on the position information regarding the second set of recognized positional transmitters; and
program code to calculate the location of the non-positional transmitter based on the first set of entry locations and the second set of entry locations.

41. The tangible machine readable medium of claim 40, further comprising:
program code to store the first set of entry locations in a storage unit; and
program code to store the second set of entry locations in the storage unit.

42. The tangible machine readable medium of claim 40, further comprising
program code to receive position information regarding a third set of recognized positional transmitters and identification information for the non-positional transmitter from a third mobile station; and
program code to calculate the location of the non-positional transmitter based on the position information regarding the first set of recognized positional transmitters, the position information regarding the second set of recognized positional transmitters and the position information regarding the third set of recognized positional transmitters.

43. The tangible machine readable medium of claim 39, further comprising:
program code to store position information regarding the first set of recognized positional transmitters; and
storing position information regarding the second set of recognized positional transmitters.

44. The tangible machine readable medium of claim 43, further comprising program code to delete position information regarding an oldest set recognized positional transmitters after position information for an entry threshold number of sets of recognized positional transmitters is received.

45. The tangible machine readable medium claim 43, further comprising:
program code to determine a most inaccurate set of recognized positional transmitters for the non-positional transmitter; and
program code to delete position information regarding the most inaccurate set of recognized positional transmitters after position data regarding an entry threshold number of sets of recognized positional transmitters for the non-positional transmitter is received.

46. A tangible machine readable medium including program code stored thereon, comprising:
program code to receive position information from a first set of recognized positional transmitters;
program code to receive identification information from a non-positional transmitter;
program code to transmit the position information from the first set of recognized positional transmitters and the identification information from the non-positional transmitter to a database server;
program code to receive a location of the non-positional transmitter from the database server; and
program code to calculate the location of the first mobile station based on the position information and the location of the non-positional transmitter using the calculation unit.

47. The tangible machine readable medium of claim 46, wherein the program code to calculate the location of the non-positional transmitter uses position information from a second set of recognized positional transmitters.

48. The tangible machine readable medium of claim 47 further comprising program code to receive the position information from the second set of recognized positional transmitters from a second mobile station.
